(19) United States
(12) Patent Application Publication
(10) Pub. No.: US 2004/0017142 A1
(43) Pub. Date: Jan. 29, 2004

(54) Multi-casing light-emission device

(76) Inventor: Jeng-Shyong Wu, Shinchu (TW)

Correspondence Address: BRUCE H. TROXELL, SUITE 1404, 5205 LEESBURG PIKE, FALLS CHURCH, VA, 22041, US

(21) Appl. No.: 10/202,843

(22) Filed: Jul. 26, 2002

(51) Int. Cl. F21V 21/00

(52) U.S. Cl. 313/318.01; 362/249

(57) ABSTRACT

A multi-casing light-emission device comprises of light-emitters, conductive wires, and a plurality of casings; wherein, the terminals of the light-emitters are connected with the conductive wires, and the conductive wires are connected to the power for supplying the light-emitting electricity; the casings are made of insulators, and each is provided with a base part and a case part, of which the base part is sealed with the middle section of the conductive wire in order to enclose the light-emitters and a part of the conductive wires inside the case part; the light-emitters are suspended at the space inside the casings; the conductive wires are extended outside the casings, so the light-emitters are enabled to emit light as the conductive wires are connected to the power.

### BACKGROUND OF THE INVENTION

1. Field of the Invention

The present invention relates to a multi-casing light-emission device, especially to a light-emission device having a plurality of casings, wherein a plurality of light-emitters are series connected, parallel connected, or series-parallel connected and are disposed internally in order to accomplish a brand-new light-emission effect.

2. Description of the Prior Art

Various models shaped as tigers, horses, leopards are usually used for displaying on general festivals or celebrations. As the models are displayed mostly at night (such as the festive lanterns on the Chinese Lantern Festival during the Lunar New Year), lights are required inside the animal-shaped models, so as to lighten and brighten the models.

As conventions, the models are displayed as various appearances by using light-bulb strings, wherein the light bulbs are fixed so simply that the light-bulb holders are formed firstly and then the light bulbs are tied thereon. Consequently, bad stability is obtained, and it is time-consuming for installing the light bulbs; moreover, it is dangerous that the light bulbs are easily to be loosened. Thus, it is restricted that it was only suitable for static display.

Alternatively, in some certain decoration models, long strings formed of independent light bulbs or LEDs that are series-connected are needed; thus, the fabrication cost is increased, and it is disadvantageous and very inconvenient to be disposed independently and stored wholly.

In consequence, the present invention is generated after being tested and improved repeatedly by the inventor of the present invention who had studied and focused on the above-mentioned situations.

### SUMMARY OF THE INVENTION

Accordingly, it is an object of the present invention to provide a multi-casing light-emission device, which is formed of at lease one light-emitter, a plurality of conductive wires, and internal and external multi casings; the light-emitter is provided with terminals for connecting the conductive wires, and the casing is an electric-insulator having a base part and a case part, wherein the base part is sealed with the middle section of the conductive wire, so the light-emitter and a part of the conductive wires are enclosed inside the case part; the light-emitter is suspended in the space inside the casing, and the conductive wire is expended outside the casing for power connection and then enable the light-emitter to emit light.

The multi-casing light-emission device according to the present invention, wherein a plurality of emitters are installed into the multi casings, thus a brand-new emission effect can be provided. This is another object of the present invention.

The multi-casing light-emission device according to the present invention, wherein the emitters are series-connected or parallel-connected, thus light-strings with various appearances are formed, and a new type of emission effect can be shown. This is a further object of the present invention.

The present invention will be better understood and its numerous objects and advantages will become apparent to those skilled in the art by referencing to the following drawings.

### BRIEF DESCRIPTION OF THE DRAWINGS

FIG. 1 is a plan view showing the present invention.

FIG. 2 is a perspective view showing the second example according to the present invention.

FIG. 3 is a perspective view showing the third example according to the present invention.

FIG. 4 is a perspective view showing the fourth example according to the present invention.

FIG. 5 is a perspective view showing the fifth example according to the present invention.

FIG. 6 is a perspective view showing the sixth example according to the present invention.

FIG. 7 is a perspective view showing the seventh example according to the present invention.

FIG. 8 is perspective view showing the eighth example according to the present invention.

FIG. 9 is a perspective view showing the ninth example according to the present invention.

FIG. 10 is a perspective view showing the tenth example according to the present invention.

FIG. 11 is a perspective view showing the eleventh example according to the present invention.

FIG. 12 is a perspective view showing the twelfth example according to the present invention.

FIG. 13 is a perspective view showing the thirteenth example according to the present invention.

### DETAILED DESCRIPTION OF THE PREFERRED EMBODIMENT

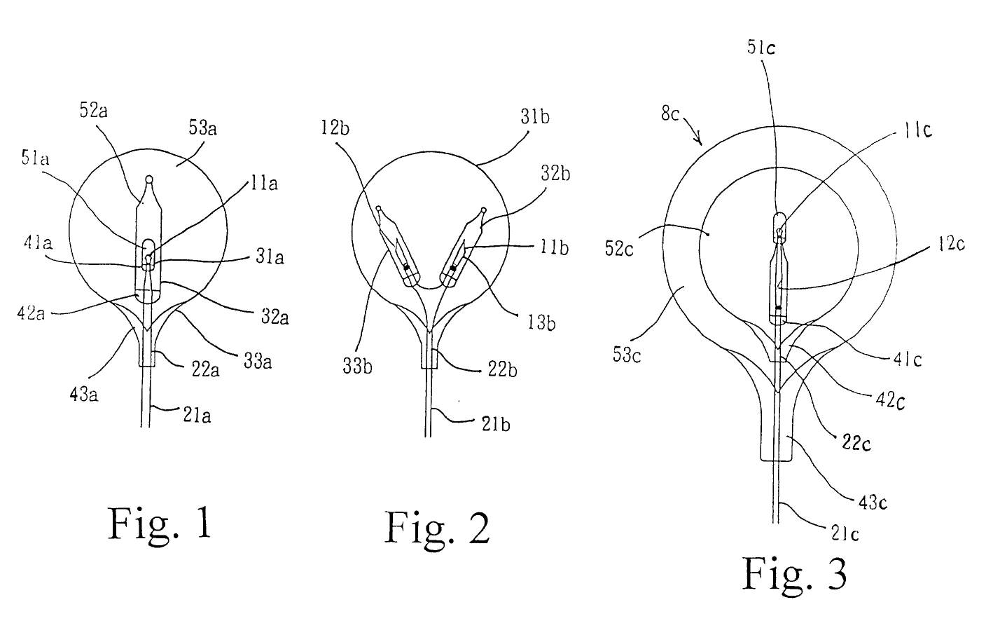

The multi-casing light-emission device according to the present invention, as shown in FIG. 1, is provided with a light-emitter 11a, which is a tungsten filament, a diode, or an LED, being suspended inside the space of the casing,s. The light-emitter 11a is provided with a terminal for connecting the electric conductive wire 21a. The middle section 22a of the conductive wire 21a is located at the internal spaces 51a, 52a, 53a of the insulating casings 31a, 32a, 33a, and one end of the wire is extended outside the casings 31a, 32a, 33a for connecting the power in order to enable the emitter 1 a to emit light. The bases 41a, 42a, 43a are located at the bottoms of the casings 31a, 32a, 33a, wherein, by means of the middle section 22a being sealed with the bases 41a, 42a, 43a, the wire 21 is passes through and is extended outwardly.

As shown in FIG. 2, the two inner casings 32b, 33b are installed inside the outer casing 31b, and the light-emitters 11b, 12b are respectively installed into the inner casings 32b, 33b. The terminals 13b of the light-emitters 11b, 12b are connected with the conductive wire 21b, and the middle section 22b of the conductive wire 21b is sealed tightly with the bottom of the bases of the casings The two inner casings 32b, 33b enable the light-emitters 11b, 12b thereof to be series connected.

As shown in FIG. 3, inner casing internal spaces 51c, 52c, 53c are arranged inside the casing 8c. Two parallel-connected light-emitters 11c, 12c are installed into the inner casing internal space 51c, and the middle section of the conductive wire 21c is sealed tightly with the bottom of the bases 41c, 42c, 43c thereof and extended outwardly.

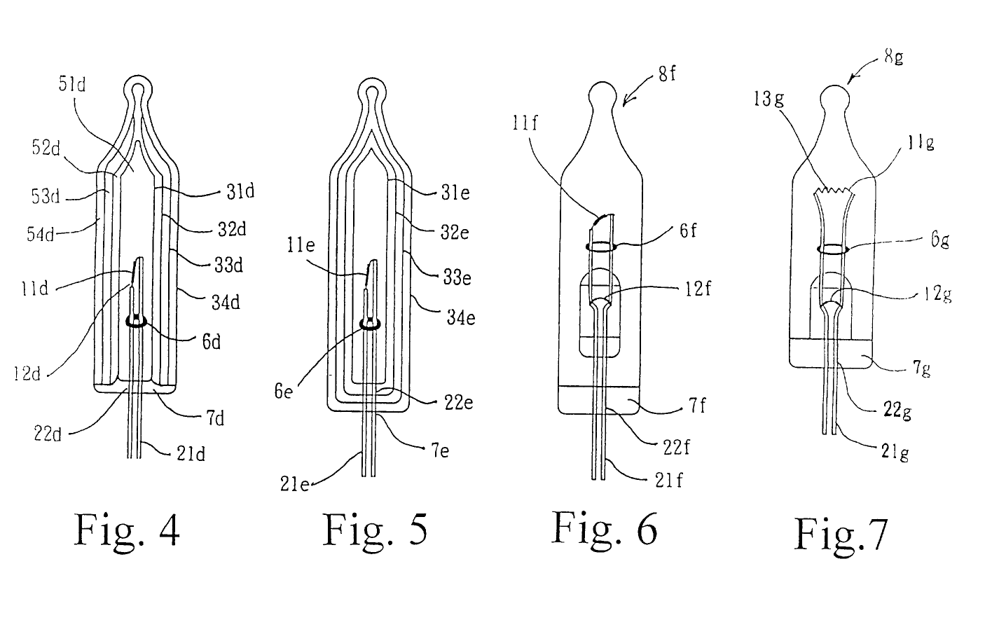

A light-bulb-shaped multi-casing formed of a plurality of casings 31d, 32d, 33d, 34d, as shown in FIG. 4, wherein the terminal 12d of the light-emitter 11d is connected with the conductive wire 21d, of which the middle section 22d is supported and fixed by an insulating supporter 6d. In particular, the bottom of the inner casings 31d, 32d, 33d are joined together, thus a common base 7d is formed, and bowl-shaped spaces 51d, 52d, 53d, 54d are formed only at the top of the casings 31d, 32d, 33d, 34d.

A light-bulb-shaped multi-casing formed of a plurality of casings 31e, 32e, 33e, 34e is shown in FIG. 5. Each of the casings 31e, 32e, 33e, 34e are independent and not joined together; thus, a circular space around the light-emitter 11e is formed. The middle section 22e of the conductive wire 21e is supported and fixed by an insulating supporter 6e, by which each of the bases 7e of the casings is pierced.

As shown in FIG. 6, two parallel-connected light-emitters 11f, 12f are installed into a casing 8f, wherein the terminal of the top emitter 11f is connected with the conductive wire 21f, and the conductive wire 21f is connected with the terminal of the bottom emitter 12f, then the wire is extended outwardly. The conductive wire 21f under the light-emitter 11f is supported and fixed by an insulating supporter 6f, and the base 7f is pierced by the middle section 22f of the conductive wire 21f.

As shown in FIG. 7, two parallel-connected light-emitters 11g, 12g are installed into a casing 8g, wherein the top emitter 11g is a tungsten filament and the terminal thereof is connected with the conductive wire 21g. The conductive wire 21g is further connected with the terminal of the bottom emitter 12g, and then it is extended outside the casing. The conductive wire 21g under the light-emitter 11g is supported and fixed by an insulating supporter 6g, and the base 7g is pierced by the middle section 22g of the conductive wire 21g.

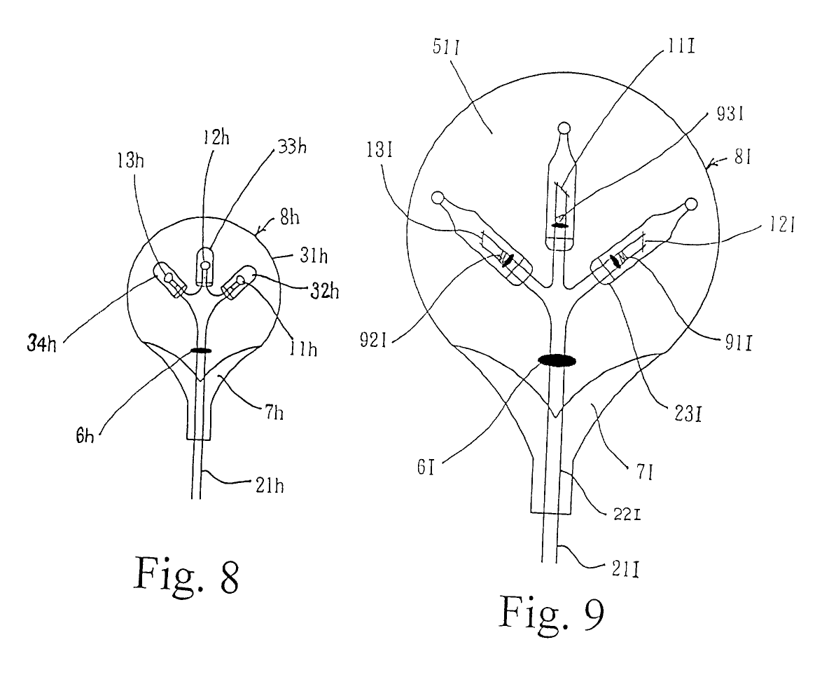

As shown in FIG. 8, three light-emitters 11h, 12h, 13h, each is enclosed by an independent casing, are installed into a casing 8h. The three emitters 11h, 12h, 13h are series-connected, and the conductive wire 21h thereof is supported and fixed by a supporter 6h and is extended outwardly by passing through the casing base 7h.

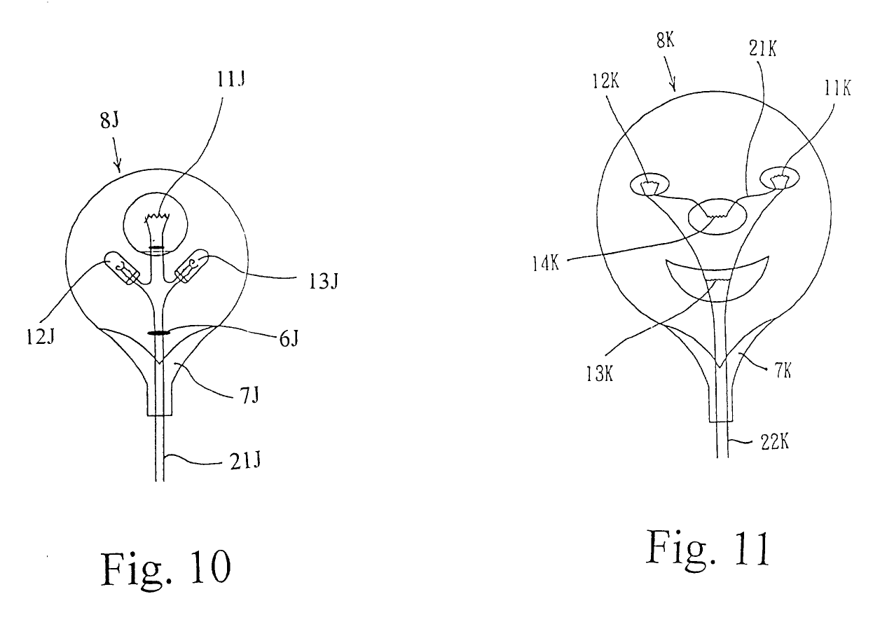

As shown in FIG. 9, three light-emitters 11i, 12i, 13i, each is enclosed by an independent, light-bulb-shaped casing, are installed into a casing 8i. The three emitters 11i, 12i, 13i are series-connected, and the conductive wire 21i thereof is supported and fixed by a supporter 6i, then is extended outwardly by passing through each independent casing base 23i and the casing base 7i with the middle section 22I of the conductive wire. Furthermore, bypass devices 91i, 92i, 93i are provided respectively for the terminals of the emitters 11i, 12i, 13i, thus the electric current is enabled to pass through the bypass devices 91i, 92i, 93i while the light-emitters 11i, 12i, 13i are fused or damaged and other series-connected light-emitters are allowed to keep on emitting.

As shown in FIG. 10, three light-emitter 11j, 12j, 13j, which are enclosed by the casings with various shape, are installed into a casing 8j. Wherein an emitter 11j is a tungsten filament, and the conductive wire 21j thereof is supported and fixed by an insulating supporter 6j and then is extended outwardly by passing through the casing base 7j.

As shown in FIG. 11, four light-emitters 11k, 12k, 13k, 14k, which are enclosed by spheral or half-moon-shaped casings, are installed in a casing 8k. The light-emitters 11k, 12k, 13k, 14k are tungsten filaments, and are series-connected and then parallel-connected by conductive wires 21k, 22k. The conductive wire 22k is extended outwardly by passing through the casing base 7k.

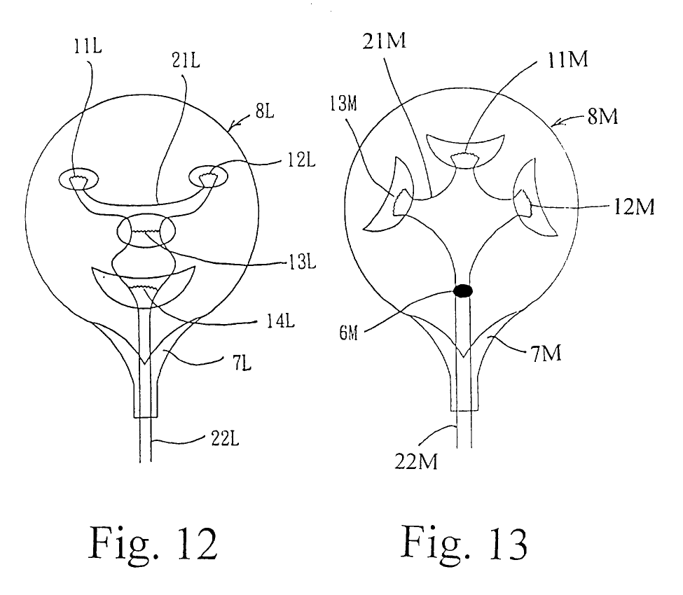

As shown in FIG. 12, four light-emitters 11l, 12l, 13l, 14l, which are enclosed by spheral or half-moon-shaped casings, are installed in a casing 8l. The light-emitters 11l, 12l, 13l, 14l are tungsten filaments, and are series-connected and then parallel-connected by conductive wires 21l, 22l. The conductive wire 22l is extended outwardly by passing through the casing base 7l.

It is known from the above FIGS. 11 and 12 that, by means of the reciprocal disposition of several light-emitters inside the cases, various internal-casing light-emitting models with more interest and aesthetic can be emerged.

As shown in FIG. 13, three light-emitters 11m, 12m, 13m, which are enclosed by spheral or half-moon-shaped casings, are installed in a casing 8m. The light-emitters 11m, 12m, 13m are tungsten filaments, and are series-connected and then parallel-connected by conductive wires 21m, 22m. The conductive wire 22m is extended outwardly by passing through the casing base 7m. The conductive wire 22m is supported and fixed by an insulating supporter 6m.

As described above, the multi-casing light-emission device according to the present invention enables various shapes of the casing appearance and brand-new light-emitting effects by means of the combinations of the series-connected, parallel-connected, or series-parallel-connected light-emitters inside the multi casings.

Although the present invention has been described using specified embodiment, the examples are meant to be illustrative and not restrictive. It is clear that many other variations would be possible without departing from the basic approach, demonstrated in the present invention.

What is claimed is:

1. A multi-casing light-emission device, formed of at least one light-emitter, a plurality of conductive wires, and a plurality of inner and outer casings;
wherein, the light-emitter is provided with a plurality of terminals for connecting with a plurality of conductive wires; the casing is an electric insulator having a base part and a case part; the base part thereof is sealed with the middle section of a part or all of the conductive wires, so as to enclose the light-emitter and a part of the conductive wire inside the case part; the light-emitter is suspended at the space inside the casing; the conductive wire is extended outside the casing for enabling the light-emitter to emit light as the conductive wire is connected with power.

2. The multi-casing light-emission device as claimed in claim 1, wherein the light-emitter is a tungsten filament, a diode, or an LED being supplied with AC or DC electricity according to the properties thereof.

3. The multi-casing light-emission device as claimed in claim 1, wherein the light-emitters are combined as a plurality of series-connections, parallel-connections, or series-parallel-connections.

4. The multi-casing light-emission device as claimed in claim 3, wherein the light-emitters are arranged and combined as patterns or in various shapes.

5. The multi-casing light-emission device as claimed in claim 3, wherein, between the single or plural series-connected light-emitters, the light-emitter connected with the conductive wire is further connected with a bypass device, thus the electric current is allowed passing through the bypass device when a light-emitter is fused or damaged, and so the other series-connected light-emitters still can emit light.

6. The multi-casing light-emission device as claimed in claim 1, wherein the terminal of the light-emitter and the conductive wire are connected by buckling, pressing, or soldering.

7. The multi-casing light-emission device as claimed in claim 1, wherein the conductive wires are supported and fixed by insulating supporters.

8. The multi-casing light-emission device as claimed in claim 1, wherein the casing is transparent, semi-transparent, or colored.

9. The multi-casing light-emission device as claimed in claim 1, wherein the hollow space of the inmost casing is a vacuum.

10. The multi-casing light-emission device as claimed in claim 1, wherein the space between the inmost casing and the next casing is a vacuum.

11. The multi-casing light-emission device as claimed in claim 1, wherein the bases of the casings are sealed with the conductive wires respectively or mutually.

12. The multi-casing light-emission device as claimed in claim 1, wherein the casings are provided with identical or different shapes.

13. The multi-casing light-emission device as claimed in claim 12, wherein the outer casing is provided with a plurality of cases and light-emitters having identical or different shapes.
